(19) United States
(12) Patent Application Publication
(10) Pub. No.: US 2010/0049508 A1
(43) Pub. Date: Feb. 25, 2010

(54) AUDIO ENCODING DEVICE AND AUDIO ENCODING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/518,378

(22) PCT Filed: Dec. 14, 2007
(86) PCT No.: PCT/JP2007/074132

§ 371 Date: Jun. 9, 2009

(30) Foreign Application Priority Data
Dec. 14, 2006 (JP) 2006-337025

(51) Int. Cl. G10L 19/04; G10L 19/12

(52) U.S. Cl. 704/219; 704/223; 704/E19.023; 704/E19.026; 704/222

(57) ABSTRACT

Provided is an audio encoding device which performs a closed loop search of a gain and a sound source vector without significantly increasing the calculation amount as compared to an open loop search. In the audio encoding device, firstly, a first parameter decision unit (121) performs a sound source search by an adaptive sound source codebook and then a second parameter decision unit (122) simultaneously performs by a closed loop, the sound source and the gain search by using a fixed sound source codebook. More specifically, for a combination of a fixed sound source vector and gain, the sum of a value obtained by multiplying a candidate fixed sound source vector by a candidate gain and a value obtained by multiplying an adaptive sound source vector by a candidate gain is subjected to a combination filter formed by a filter coefficient based on a quantization linear prediction coefficient so as to generate a combined signal. An encoded distortion as a distance between the combined signal and the input signal is calculated so as to search for the code and the gain of the fixed sound source vector which minimizes the encoded distortion.

### TECHNICAL FIELD

The present invention relates to a speech encoding apparatus and speech encoding method for encoding speech by CELP (Code Excited Linear Prediction).

### BACKGROUND ART

In mobile communication, it is necessary to compress and encode digital information such as speech and images to efficiently utilize radio channel capacity and a storing medium, and, therefore, many encoding/decoding schemes have been developed so far.

Performance of the speech coding technique has significantly improved thanks to the fundamental scheme “CELP” of ingeniously applying vector quantization by modeling the vocal tract system.

Here, with CELP, there area great number of pieces of information of encoding targets such as the spectral envelope of LPC (linear prediction coefficient) parameters, excitations in an adaptive excitation codebook and fixed excitation codebook, and gains of the two excitations, and, therefore, it is necessary to reduce the amount of calculation for searching for these.

The typical encoding steps of each information in CELP that is conventionally performed will be explained below using FIG. 1.

First, a liner prediction analysis of an input signal is performed to extract the LPC parameters to transform into LSP (Line Spectrum Pair) vectors. Then, VQ (Vector Quantization) of the vectors is performed to determine LPC codes.

Next, the LPC codes are decoded to find decoded parameters to form a synthesis filter with these parameters.

Next, an excitation search is performed using an adaptive excitation codebook alone. To be more specific, assuming an ideal gain (i.e. the gain that minimizes the distortion), values multiplying adaptive excitation vectors stored in the adaptive excitation codebook by the above ideal gain, are applied to the above synthesis filter to generate synthesized signals. Next, coding distortion, which is the distances between these synthesized signals and an input speech signal, is calculated. Then, the code for the adaptive excitation vector that minimizes this coding distortion is searched for.

Next, the searched code is decoded to find the decoded adaptive excitation vector.

Next, an excitation search is performed using the fixed excitation codebook. To be more specific, assuming ideal gains (two kinds of the gain of the adaptive excitation vector and the gain of the fixed excitation vector), values multiplying fixed excitation vectors in the fixed excitation codebook by the ideal gains and values multiplying the above decoded adaptive excitation vectors by the ideal gains are added and applied to the above synthesis filter to generate synthesized signals. Next, coding distortion, which is the distances between these synthesized signals and an input speech signal, is calculated. Then, the code for the adaptive excitation vector that minimizes this coding distortion is searched for.

Next, the searched code is decoded to find a decoded fixed excitation vector.

Next, the gains of the above decoded adaptive excitation vector and the above decoded fixed excitation vector are quantized. To be more specific, the above two excitation vectors are multiplied by gain candidates and then are applied to the above synthesis filter, the gains that become similar to an input signal are searched for, and, finally, the searched gain is quantized.

In this way, with conventional CELP, to reduce the amount of calculation, an open loop search algorithm for searching for one piece of information by fixing other information and searching for code one by one is employed. Therefore, CELP could not provide satisfying performance.

To solve this problem, conventionally, a closed loop search method whereby the amount of calculation does not increase significantly has been studied. Patent Document 1 discloses a fundamental invention of finding optimal codes at the same time using preliminary selection in searches using an adaptive excitation codebook and fixed excitation codebook. According to this method, it is possible to search for two codebooks by closed-loop.

Patent Document 1: Japanese Patent Application Laid-Open No. HEI5-019794

### DISCLOSURE OF INVENTION

### Problems to be Solved by the Invention

However, closed loop search using the adaptive excitation codebook and closed loop search using the fixed excitation codebook are configured to add vectors in the adaptive excitation codebook and fixed excitation codebook and, therefore, are comparatively independent from each other, and cannot realize such significant performance improvement compared to open loop search.

By contrast with this, if two parameters are multiplied, closed loop search provides a significant advantage. CELP has made possible significant performance improvement by means of analysis by synthesis using an LPC synthesis filter for an algorithm of searching for excitation vectors and gains, because the synthesis filter and two of the excitation vectors and gains are multiplied.

Although gains and excitation vectors are multiplied in addition to the synthesis filter, conventional techniques related to closed loop search for gains and closed loop search for excitation vectors only disclose increasing the amount of calculation significantly.

In view of the above, it is therefore an object of the present invention to provide a speech encoding apparatus and speech encoding method that perform closed loop search for gains and closed loop search for excitation vectors without increasing the amount of calculation significantly compared to open loop search and that realizes significant performance improvement.

### Means for Solving the Problem

A speech encoding apparatus according to the present invention has: a first parameter determining section that searches for a code for an adaptive excitation vector in an adaptive excitation codebook; and a second parameter determining section that performs a closed loop search for a code for a fixed excitation vector in a fixed excitation codebook and a gain, and employs a configuration where the second parameter determining section: generates, for combination of fixed excitation vectors and gains, a synthesized signal by adding a value multiplying a candidate fixed excitation vector by a fixed excitation candidate gain and a value multiplying the adaptive excitation vector by an adaptive excitation candidate gain and by applying an addition value to a synthesis filter configured with filter coefficients based on quantization linear prediction coefficients; calculates coding distortion that is a distance between the synthesized signal and an input speech signal; and searches for a code for a fixed excitation vector and a gain that minimize the coding distortion.

A speech encoding method according to the present invention includes: a first step of searching for a code for an adaptive excitation vector in an adaptive excitation codebook; and a second step of performing a closed loop search for a code for a fixed excitation vector in a fixed excitation codebook and a gain, whereby the second step: generates, for combination of fixed excitation vectors and gains, a synthesized signal by adding a value multiplying a candidate fixed excitation vector by a fixed excitation candidate gain and a value multiplying the adaptive excitation vector by an adaptive excitation candidate gain and by applying an addition value to a synthesis filter configured with filter coefficients based on quantization linear prediction coefficients; calculates coding distortion that is a distance between the synthesized signal and an input speech signal; and searches for a code for a fixed excitation vector and a gain that minimize the coding distortion.

### ADVANTAGEOUS EFFECT OF THE INVENTION

According to the present invention, it is possible to perform closed loop search for gains and closed loop search for fixed excitation vectors without performing a vector arithmetic operation, so that it is possible to realize significant performance improvement without increasing the amount of calculation significantly compared to open loop search.

### BRIEF DESCRIPTION OF DRAWINGS

FIG. 1 is a flowchart of conventional encoding steps;

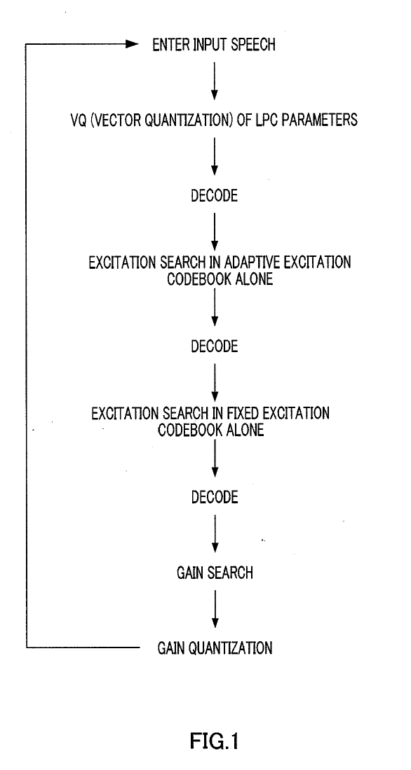

FIG. 2 is a block diagram showing a configuration of a speech encoding apparatus according to Embodiment 1 of the present invention;

FIG. 3 is a flowchart of encoding steps according to Embodiment 1 of the present invention; and

FIG. 4 is a flowchart showing an algorithm of closed loop search using a fixed excitation codebook and closed loop search for gains according to Embodiment 1 of the present invention.

### BEST MODE FOR CARRYING OUT THE INVENTION

Embodiments of the present invention will be explained below using drawings.

### Embodiment 1

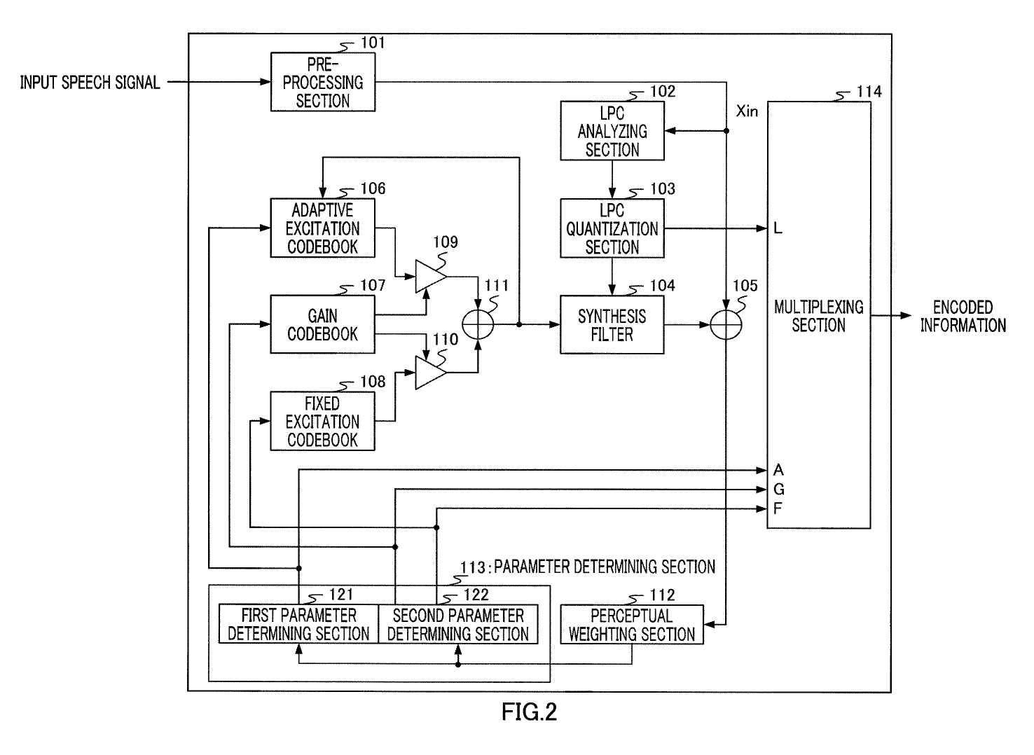

FIG. 2 is a block diagram showing a configuration of a speech encoding apparatus according to Embodiment 1.

Pre-processing section 101 performs high pass filtering processing for removing the DC components and waveform shaping processing or pre-emphasis processing for improving the performance of subsequent encoding processing, with respect to an input speech signal, and outputs the signal (Xin) after these processings, to LPC analyzing section 102 and adding section 105.

LPC analyzing section 102 performs a linear prediction analysis using Xin, and outputs the analysis result (i.e. linear prediction coefficients) to LPC quantization section 103. LPC quantization section 103 carries out quantization processing of linear prediction coefficients (LPC's) outputted from LPC analyzing section 102, and outputs the quantized LPC's to synthesis filter 104 and a code (L) representing the quantized LPC's to multiplexing section 114.

Synthesis filter 104 carries out filter synthesis for an excitation outputted from adding section 111 (explained later) using filter coefficients based on the quantized LPC'S, to generate a synthesized signal and output the synthesized signal to adding section 105.

Adding section 105 inverts the polarity of the synthesized signal and adds the signal to Xin to calculate an error signal, and outputs the error signal to perceptual weighting section 112.

Adaptive excitation codebook 106 stores past excitations outputted from adding section 111 in a buffer, clips one frame of samples from the past excitations as an adaptive excitation vector that is specified by a signal outputted from parameter determining section 113, and outputs the adaptive excitation vector to multiplying section 109.

Gain codebook 107 outputs the gain of the adaptive excitation vector that is specified by the signal outputted from parameter determining section 113 and the gain of a fixed excitation vector to multiplying section 109 and multiplying section 110, respectively.

Fixed excitation codebook 108 outputs as a fixed excitation vector a pulse excitation vector having a shape that is specified by the signal outputted from parameter determining section 113 or a vector acquired by multiplying by a dispersion vector the pulse excitation vector, to multiplying section 110.

Multiplying section 109 multiplies the adaptive excitation vector outputted from adaptive excitation codebook 106, by the gain outputted from gain codebook 107, and outputs the result to adding section 111. Multiplying section 110 multiplies the fixed excitation vector outputted from fixed excitation codebook 108, by the gain outputted from gain codebook 107, and outputs the result to adding section 111.

Adding section 111 receives as input the adaptive excitation vector and fixed excitation vector after gain multiplication, from multiplying section 109 and multiplying section 110, adds these vectors, and outputs an excitation representing the addition result to synthesis filter 104 and adaptive excitation codebook 106. Further, the excitation inputted to adaptive excitation codebook 106 is stored in a buffer.

Perceptual weighting section 112 applies perceptual weighting to the error signal outputted from adding section 105, and outputs the error signal to parameter determining section 113 as coding distortion.

Parameter determining section 113 searches for the codes for the adaptive excitation vector, fixed excitation vector and a code of gain that minimize the coding distortion outputted from perceptual weighting section 112, and outputs the searched code (A) representing the adaptive excitation vector, code (F) representing the fixed excitation vector and code (G) representing the code of gain, to multiplexing section 114.

Characteristics of the present invention lie in a method of searching for fixed excitation vectors and gains in parameter determining section 113. That is, first, first parameter determining section 121 performs an excitation search using an adaptive excitation codebook alone, and then second parameter determining section 122 performs an excitation search using a fixed excitation codebook and a gain search by closed loop at the same time.

Multiplexing section 114 receives as input the code (L) representing the quantized LPC's from LPC quantizing section 103, receives as input the code (A) representing the adaptive excitation vector, the code (F) representing the fixed excitation vector and the code (G) representing the gain from parameter determining section 113, and multiplexes these items of information to output encoded information.

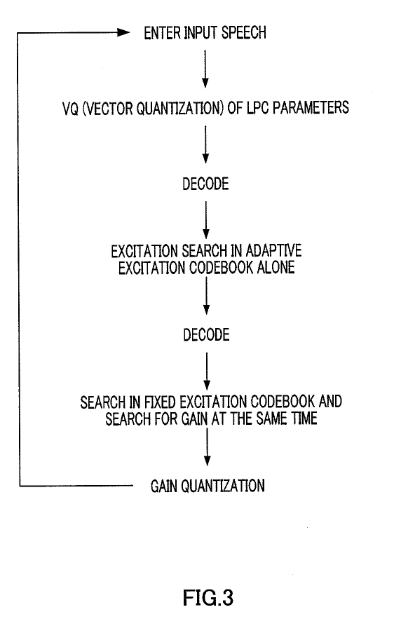

Next, encoding steps according to the present embodiment will be explained using FIG. 3.

First, a liner prediction analysis of an input signal is performed to extract the LPC parameters to transform into LSP (Line Spectrum Pair) vectors. Then, VQ (Vector Quantization) of the vectors is performed to determine LPC codes.

Next, the LPC codes are decoded to find the decoded parameters to form a synthesis filter with these parameters.

Next, an excitation search is performed using an adaptive excitation codebook alone. To be more specific, assuming an ideal gain (i.e. the gain that minimizes the distortion), values multiplying adaptive excitation vectors stored in the adaptive excitation codebook by the above ideal gain, are applied to the above synthesis filter to generate synthesized signals. Next, coding distortion, which is the distance between these synthesized signals and an input speech signal, is calculated. Then, the code for the adaptive excitation vector that minimizes this coding distortion is searched for.

Next, the searched code is decoded to find the decoded adaptive excitation vector.

Next, an excitation search using the fixed excitation codebook and a gain search are performed at the same time by closed loop. To be more specific, for all combinations of fixed excitation vectors and gains, values multiplying candidate fixed excitation vectors by candidate gains and values multiplying the above decoded adaptive excitation vectors by candidate gains are added and applied to the above synthesis filter to generate synthesized signals. Next, coding distortion, which is the distance between these synthesized signals and an input speech signal is calculated. Then, the code for the fixed excitation vector that minimizes this coding distortion is searched for.

Lastly, the searched two vector gains are quantized.

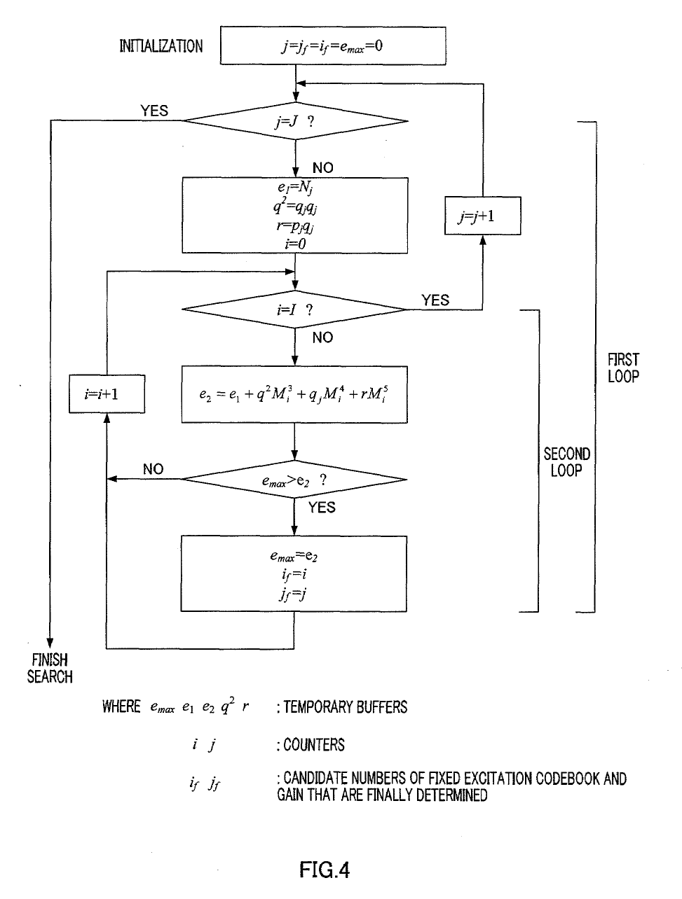

Next, an algorithm for closed loop search using a fixed excitation codebook and closed loop search for gains will be explained in detail using the flowchart of FIG. 4 and equations.

Equation 1 represents coding distortion E used in a code search in CELP. Processing in a coder is directed to searching for the code that minimizes this coding distortion E. Further, in equation 1, x is the encoding target (i.e. input speech), p is the adaptive excitation gain, H is the impulse response of an LPC synthesis filter, a is the adaptive excitation vector, q is the fixed excitation gain and s is the fixed excitation vector.

(Equation 1)

E=|x−(pHa+qHs)|² [1]

Following equation 2 holds by developing above equation 1. Hereinafter, the indices will be assigned for expression in the following explanation. Although an adaptive excitation vector is encoded and decoded in advance and is represented as is by the above symbol, the fixed excitation vector will be assigned index i and represented as sᵢ. Further, as for gains, the adaptive excitation gain p and fixed excitation gain q are collectively subjected to vector quantization, and will be assigned the same index j and represented as pⱼ and qⱼ.

(Equation 2)

E=x′x+p²a^{t}H^{t}Ha−2px^{t}Ha+q²s^{t}H^{t}Hs−2qx^{t}Hs+2pqa^{t}H^{t}Hs [2]

where t is a transpose symbol

Here, with the present embodiment, before closed loop search using a fixed excitation codebook and closed loop search for gains are performed, a mid-calculation values that are not related to the fixed excitation vector sᵢ or gain qⱼ is calculated in advance.

First, the first term of above equation 2 is the power of the target and does not have to do with a codebook search, and so will be omitted below. Further, because the second term and the third term in above equation 2 are not related to the gain qⱼ and fixed excitation vector sᵢ, elements other than the gain pⱼ in the second term and the third term adopt mid-calculation values M¹ and M², as shown in following equation 3. Further, a search for adaptive excitation vectors is finished in advance with the present embodiment and, consequently, the second term and the third term in above equation 2 both become scalar values.

(Equation 3)

M¹=a^{t}H^{t}Ha

M²=−2x^{t}Ha [3]

Further, because the fourth term and the fifth term in above equation 2 are not related to the gain pⱼ, elements other than the gain qⱼ in the fourth term and the fifth term adopt mid-calculation values M³ and M⁴, as shown in following equation 4. Furthermore, in equation 4, I is the number of fixed excitation vector candidates.

(Equation 4)

Mᵢ²=sᵢ^{t}H^{t}Hsᵢ

Mᵢ⁴=−2x^{t}Hsᵢ [4]

i=1 . . . I

Further, elements other than gains pⱼ and qⱼ in the sixth term in above equation 2 adopt the mid-calculation value M⁵, as shown in following equation 5.

(Equation 5)

Mᵢ⁵=2a^{t}H^{t}Hsᵢ [5]

i=1 . . . I

Here, the second term and the third term can be added with respect to all possible gain candidates in advance in above equation 2, and therefore adopt mid-calculation value Nⱼ, as shown in following equation 6. Further, in equation 6, J is the number of gain candidates (i.e. the number of vectors with the present embodiment).

(Equation 6)

Nⱼ=pⱼ^{p}ⱼM₁+pⱼM₂ [6]

j=1 . . . J

In this way, with the present embodiment, mid-calculation values are calculated in advance and round robin search for the numbers of candidate vectors using a fixed excitation codebook and round robin search for the numbers of candidate gains are performed at the same time. As shown in FIG. 4, the closed loop search of the present embodiment employs a two-fold loop configured by a search loop (first loop) for the gain including a search loop (second loop) for the fixed excitation codebook.

Characteristics of search processing shown in FIG. 4 lie in that all calculations in loops are simple calculations of numerical values and there is no vector arithmetic operation. As a result, it is possible to contain the required amount calculation at minimum.

In this way, with the present embodiment, closed loop search for gains and closed loop search using a fixed excitation vector can be performed without performing a vector arithmetic operation in the CELP scheme, so that it is possible to realize significant performance improvement without increasing the amount of calculation significantly compared to open loop search.

Further, by finding the mid-calculation values M¹, M² and Nⱼ in advance, it is possible to reduce the amount of calculation for a gain search (i.e. first loop) significantly. Similarly, by finding the mid-calculation values M³, M⁴ and M⁵ in advance, it is possible to reduce the amount of calculation for a fixed excitation vector search (i.e. second loop) significantly.

### Embodiment 2

A case will be explained with Embodiment 2 where, a scaling coefficient is calculated in advance for every number of pulses when a fixed excitation vector is a vector formed by a small number of pulses or a scaling coefficient is calculated in advance for every kind of a dispersion vector when a fixed excitation vector is a vector dispersing the vector of a smaller number of pulses to store in a memory, and gains are quantized by multiplying a fixed excitation vector by a scaling coefficient in closed loop search using the fixed excitation codebook and closed loop search for gains. The scaling coefficient in the present embodiment is the inverse of the value representing the magnitude (i.e. amplitude) of a fixed excitation vector and depends on the number of pulses or the kind of the dispersion vector.

In closed loop search using a fixed excitation codebook and closed loop search for gains, using a scaling coefficient is equivalent to multiplying a gain qⱼ by scaling coefficient v, and above equation 2 is changed to following equation 7.

(Equation 7)

E=x^{t}x+p²a^{t}H^{t}Ha−2px^{t}Ha+q²s^{t}H^{t}Hs v²−2qx^{t}Hs v+2pqa^{t}H^{t}Hs v [7]

The above scaling coefficient v is determined depending on the number of pulses and is calculated in advance as in following equation 8. Further, in equation 8, kᵢ is the number of pulses in the i-th fixed excitation vector. This equation 8 of the codebook matches a case where the magnitude of an impulse is one.

(Equation 8)

vᵢ=1/\sqrt{kᵢ} [8]

i=1 . . . I

Further, there are cases where the scaling coefficient that is defined as above is further divided by a vector length before square root calculation. These are the cases where, for example, the scaling coefficient is defined as the inverse of the average amplitude of one sample.

When a dispersion vector is further used, the average amplitude varies depending on dispersion vectors. In this case, as in following equation 9, that is, an average amplitude of all excitation vector candidates for every number of pulses or for every dispersing vector or a coefficient based on a number of pulses is used for an approximate value, it is possible to find one scaling coefficient for every number of pulses or for every dispersion vector. However, the calculation in following equation 9 is only an approximate calculation. This is because, when a pulse is dispersed, dispersion vectors are overlapped in positions of pulses and power varies between pulse positions. Further, in equation 9, dₖ^{mi} is the dispersion vector, and mᵢ is the dispersion vector number of the i-th fixed excitation vector.

$$\begin{matrix}( Equation 9 ) & \\ {v}_{i} = 1 / \sqrt{{k}_{i} \times {Pd}_{{m}_{i}}} \\ i = 1 … I \\ Where , {Pd}_{{m}_{i}} = {\sum }_{k} {d}_{k}^{{m}_{i}} \times {d}_{k}^{{m}_{i}} & [ 9 ]\end{matrix}$$

Accordingly, when each scaling coefficient v is determined for every number of pulses or for every kind of a dispersion vector, the mid-calculation values M³, M⁴ and M⁵ are represented as in following equation 10 using the above scaling coefficient.

(Equation 10)

Mᵢ³=sᵢ^{t}H^{t}Hsᵢvᵢ²

Mᵢ⁴=−2x^{t}Hsᵢvᵢ

Mᵢ⁵==2a^{t}H^{t}Hsᵢvᵢ [10]

i=1 . . . I

In this way, according to the present embodiment, even if there is processing associated with scaling, mid-calculation values can cover this processing, so that it is possible to realize closed loop search using a fixed excitation codebook and closed loop search for gains similar to cases where scaling is not used.

Further, when an algebraic codebook is used as a fixed excitation codebook, the above two mid-calculation values M³ and M⁴ correspond to the denominator term and the numerator term of the cost function in an algebraic codebook search. Further, encoding is performed in the algebraic codebook based on a pulse position and pulse polarity (+−). In this case, with reference to the polarities of the elements of vector x^{t}H, the polarity of a pulse is used as the reference value for the pulse position, and, consequently, degradation of performance can be minimized and a polarity search can be skipped, so that it is possible to reduce the kinds of indices i and further reduce the amount of calculation for closed loop search. For example, when the number of pulses is three and the number of entries in each channel is {16, 16, 8}, the amount of information (i.e. the number of bits) is 14 bits (I=16384 patterns) of (4+4+3) bits (for positions) and (1+1+1) bits (for polarities). If the polarity is not the target to search for, only 11 bits (I=2048 patterns) are required. Accordingly, using an algebraic codebook in above Embodiment 1 is effective to reduce the amount of calculation.

Further, providing various numbers of pulses in an algebraic codebook as a fixed excitation codebook yields an advantage of improving sound quality. This is clear from the tendency that it is adequate to use a small number of pulses in voiced portions that are close to vocal cord waves and use a great number of pulses in unvoiced portions or portions of environmental noise. For example, it is assumed that two, three and four pulses are used for the variations of the number of pulses and the length of a subframe is forty samples. The number of entries of each channel is {20,20} when the number of pulses is two and the amount of information is 20×20×2²=1600 patterns, the number of entries is {16,16,8} when the number of pulses is three and the amount of information is 16×16×8×2³=16384 patterns and the number of entries is {16,8,8,8} when the number of pulses is four and the amount of information is 16×8×8×8×2⁴=131072 patterns, and an input speech signal is encoded with 17 to 18 bits in total on a per subframe basis.

Further, using a dispersed excitation, that is, convoluting a dispersion vector in a pulse to create a fixed excitation vector, produces an advantage of improving sound quality. This technique can assign various characteristics to a fixed excitation vector. In this case, power varies between dispersion vectors to use.

Further, although a case has been explained with the present embodiment as an example where an algebraic codebook is used in explanation for a fixed excitation codebook, the present invention is also effective when there are various numbers of pulses as in a multipath codebook and the like.

Further, the present invention is effective in a fixed excitation codebook consisted of full of pulses (that is, there are values in all positions) other than excitations. This is because a scaling coefficient only needs to be calculated using a small number of representative values resulting from clustering of power of an excitation vector in advance, and stored. In this case, it is necessary to store the associations between the indices of fixed excitations and scaling coefficients to use.

Further, although, with the above embodiments, a search is performed in an adaptive excitation codebook in advance and closed loop search using a fixed excitation codebook and closed loop search for gains are performed, the present invention is not limited to this and closed loop search may also be performed using an adaptive excitation codebook. However, in this case, although mid-calculation values in the adaptive excitation codebook can be calculated similar to mid-calculation values relating to a fixed excitation codebook of the above embodiments, the last portion of processing in closed loop search adopts a three-fold loop and therefore the amount of calculation is likely to be enormous. In this case, it is possible to decrease the number of adaptive excitation vector candidates and reduce the amount of calculation to the feasible amount of calculation by performing preliminary selection in the adaptive excitation codebook.

Further, although round robin closed loop search for candidate vectors using a fixed excitation codebook and round robin closed loop search for candidate gains are performed with the above embodiments, the present invention is not limited to this and preliminary selections for candidate vectors or candidate gains can be combined, so that it is possible to further reduce the amount of calculation.

Furthermore, even when adaptive excitation vectors are encoded and then gains of adaptive excitation vectors are encoded, the present invention can realize closed loop search using a fixed excitation codebook and closed loop search for gains of fixed excitation vectors as in the above embodiments.

Still further, although a case has been explained with the above embodiments where the present invention is used for CELP, the present invention is not limited to this and is also effective in encoding using excitation codebooks. This is because the present invention is directed to closed loop search using a fixed excitation vector and closed loop search for gains, and does not depend on whether or not there is an adaptive excitation codebook and the method of spectral envelope analysis.

Further, an input signal in the speech encoding apparatus according to the present invention may be not only a speech signal but also an audio signal. Furthermore, a configuration may be possible where the present invention is applied to an LPC prediction residual signal rather than an input signal.

Furthermore, the speech decoding apparatus according to the present invention can be provided in a communication terminal apparatus and base station apparatus in a mobile communication system, so that it is possible to provide a communication terminal apparatus, base station apparatus and mobile communication system having the same operations and advantages as explained above.

Also, although cases have been explained here as examples where the present invention is configured by hardware, the present invention can also be realized by software. For example, it is possible to implement the same functions as in the base station apparatus according to the present invention by describing algorithms according to the present invention using the programming language, and executing this program with an information processing section by storing this program in the memory.

Each function block employed in the explanation of each of the aforementioned embodiment may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if the integrated circuit technology comes out to replace LSI's as a result of the advancement of semiconductor technology or a derivative other technology, it is also naturally possible to carry out function block integration using this technology. Application of biotechnology is also possible.

The disclosure of Japanese Patent Application No. 2006-337025, filed on Dec. 14, 2006, including the specification, drawings and abstract, is incorporated herein by reference in its entirety.

### INDUSTRIAL APPLICABILITY

The present invention is suitable for use in a speech encoding apparatus and the like that encodes speech by CELP.

1. A speech encoding apparatus comprising:
a first parameter determining section that searches for a code for an adaptive excitation vector in an adaptive excitation codebook; and
a second parameter determining section that performs a closed loop search for a code for a fixed excitation vector in a fixed excitation codebook and a gain,
wherein the second parameter determining section:
generates, for combination of fixed excitation vectors and gains, a synthesized signal by adding a value multiplying a candidate fixed excitation vector by a fixed excitation candidate gain and a value multiplying the adaptive excitation vector by an adaptive excitation candidate gain and by applying an addition value to a synthesis filter configured with filter coefficients based on quantization linear prediction coefficients;
calculates coding distortion that is a distance between the synthesized signal and an input speech signal; and
searches for a code for a fixed excitation vector and a gain that minimize the coding distortion.

2. The speech encoding apparatus according to claim 1, wherein the second parameter determining section:
calculates in advance a mid-calculation values that are not related to the fixed excitation vector or the gain in the coding distortion; and
performs the closed loop search using the mid-calculation value in a two-fold loop configured by a search loop for the gain including a search loop for the fixed excitation codebook.

3. The speech encoding apparatus according to claim 1, wherein the second parameter determining section:
calculates a scaling coefficient in advance for every number of pulses when the fixed excitation vector comprises a vector consisted of a predetermined number of pulses or calculates the scaling coefficient in advance for every kind of a dispersion vector when the fixed excitation vector comprises a vector dispersing the vector consisted of the predetermined number of pulses, to store in a memory; and
quantizes the gain by multiplying the fixed excitation vector by the scaling coefficient in the closed loop search.

4. A speech encoding method comprising:
a first step of searching for a code for an adaptive excitation vector in an adaptive excitation codebook; and
a second step of performing a closed loop search for a code for a fixed excitation vector in a fixed excitation codebook and a gain,
wherein the second step:
generates, for combination of fixed excitation vectors and gains, a synthesized signal by adding a value multiplying a candidate fixed excitation vector by a fixed excitation candidate gain and a value multiplying the adaptive excitation vector by an adaptive excitation candidate gain and by applying an addition value to a synthesis filter configured with filter coefficients based on quantization linear prediction coefficients;
calculates coding distortion that is a distance between the synthesized signal and an input speech signal; and
searches for a code for a fixed excitation vector and a gain that minimize the coding distortion.

5. The speech encoding apparatus according to claim 4, wherein the second step:
calculates in advance a mid-calculation values that are not related to the fixed excitation vector or the gain in the coding distortion; and
performs the closed loop search using the mid-calculation value in a two-fold loop configured by a search loop for a gain including a search loop for a fixed excitation codebook.

6. The speech encoding apparatus according to claim 4, wherein the second step:
calculates a scaling coefficient in advance for every number of pulses when the fixed excitation vector comprises a vector consisted of a predetermined number of pulses or calculates the scaling coefficient in advance for every kind of a dispersion vector when the fixed excitation vector comprises a vector dispersing the vector consisted of the predetermined number of pulses, to store in a memory; and
quantizes the gain by multiplying the fixed excitation vector by the scaling coefficient in the closed loop search.
